(19) United States
(12) Patent Application Publication
(10) Pub. No.: US 2007/0188967 A1
(43) Pub. Date: Aug. 16, 2007

(54) Solenoid driver circuit

(75) Inventors: Stephen W. Smith, South Lyon, MI (US); Subbaraya Radhamohan, Novi, MI (US); Thomas J. Stoltz, Allen Park, MI (US)

Correspondence Address: Anna M. Shih, 26201 Northwestern Hwy., P.O. Box 766, Southfield, MI, 48037, US

(73) Assignee: Eaton Corporation, Cleveland, OH (US)

(21) Appl. No.: 11/351,508

(22) Filed: Feb. 10, 2006

(51) Int. Cl. H01H 47/32; H01H 47/00

(52) U.S. Cl. 361/155

(57) ABSTRACT

A solenoid drive circuit includes a boost energy storage device, such as a capacitor, that captures energy from and discharges energy to a solenoid. Switches control the connection between the boost device, the solenoid, and a power source. This allows the solenoid response time to be variable based on the characteristics of the boost device as well as the solenoid. By providing two different solenoid current rise and decay rates and by capturing and re-using energy stored in the solenoid, the inventive drive circuit enhances solenoid response and increases efficiency.

### TECHNICAL FIELD

The present invention relates to solenoid driver circuits, and more particularly to a solenoid driver circuit that captures and stores energy that is later re-used in the circuit.

### BACKGROUND OF THE INVENTION

For fast solenoid actuation, it is desirable to increase and decrease the inductor current through the solenoid as quickly as possible. For conventional driver circuits (i.e., high-side and low-side drivers), the rise and fall rates of the inductor current is determined by the voltage applied to the solenoid coil inductor-resistor time constant L/R, with L=the inductance of the solenoid coil and R=the resistance of the coil.

There is a desire for an improved solenoid driver that improves the actuation speed, controllability and energy efficiency of a solenoid. There is also a desire for a solenoid-operated spool valve having enhanced controllability and actuation time.

### SUMMARY OF THE INVENTION

The invention is directed to a solenoid drive circuit that includes a boost energy storage device that absorbs energy from and discharges energy to a solenoid. Switching devices control the connection between the boost device, the solenoid, and a power source. This allows the voltage excitation to the circuit, and therefore the solenoid response time, to be variable based on the characteristics of the boost device as well as the solenoid. By providing two different solenoid rise and decay rates and by capturing and re-using energy stored in the solenoid, the inventive drive circuit enhances solenoid response and increases efficiency.

### BRIEF DESCRIPTION OF THE DRAWINGS

FIG. 1 is a representative schematic diagram of a drive circuit according to one embodiment of the invention.

FIG. 2 is a flow diagram illustrating a solenoid current control process according to one embodiment of the invention;

FIG. 3 is a representative schematic diagram of a drive circuit according to a further embodiment of the invention;

FIG. 4 is a representative schematic diagram of yet another embodiment of the invention;

FIG. 5 is a representative schematic diagram of another embodiment of the invention; and

FIG. 6 is a flow diagram illustrating a solenoid current control process according to another embodiment of the invention.

### DETAILED DESCRIPTION OF THE EMBODIMENTS

A circuit according to the invention includes a boost energy storage device, such as a capacitor, that supplies boost energy to a solenoid. This additional circuitry provides faster solenoid current rise and decay rates than a conventional high or low side drive circuit. More particularly, the current rise and fall times in the inventive circuit is not determined by the L/R time constant. Instead, the times are determined by the time required for the capacitor to discharge completely into the solenoid coil inductance or absorb the energy from the inductance. The time constant t₁ is less than or equal to around 1.57×(L×C)^{1/2} seconds, where L=the inductance of the solenoid coil and C=is the capacitance of the energy storage device. Note that although the examples below assume that the energy storage device is a capacitor, other devices may be used without departing from the scope of the invention.

The increased voltage provided by the energy storage device provides a faster initial rise rate and a faster ending fall rate for the solenoid, creating a quicker solenoid response at the beginning and end of solenoid actuation. Response times of less than t₁=1.57×(L×C)^{1/2} seconds may be obtained by using a high capacitor voltage and shutting off the discharge before the capacitor is completely discharged to V_{battery}. Thus, the discharge may be either partial or complete, depending on the desired response speed. This allows the current in the solenoid coil inductor to increase faster and not be restricted by the conventional L/R time constant. The switching time may also be determined by the solenoid current as well as the capacitor voltage.

The solenoid in the circuit may be driven using pulse width modulation (PWM), allowing the current in the solenoid to be controlled at a level that is less than the final DC value V/R (supply voltage divided by solenoid resistance) dictated by the solenoid 104. As a result, the circuit 100 is flexible enough to operate using the slower L/R time constant to facilitate PWM operation. The ability for the circuit 100 to change solenoid current rise and decay times of different speeds provides increased drive control over the solenoid.

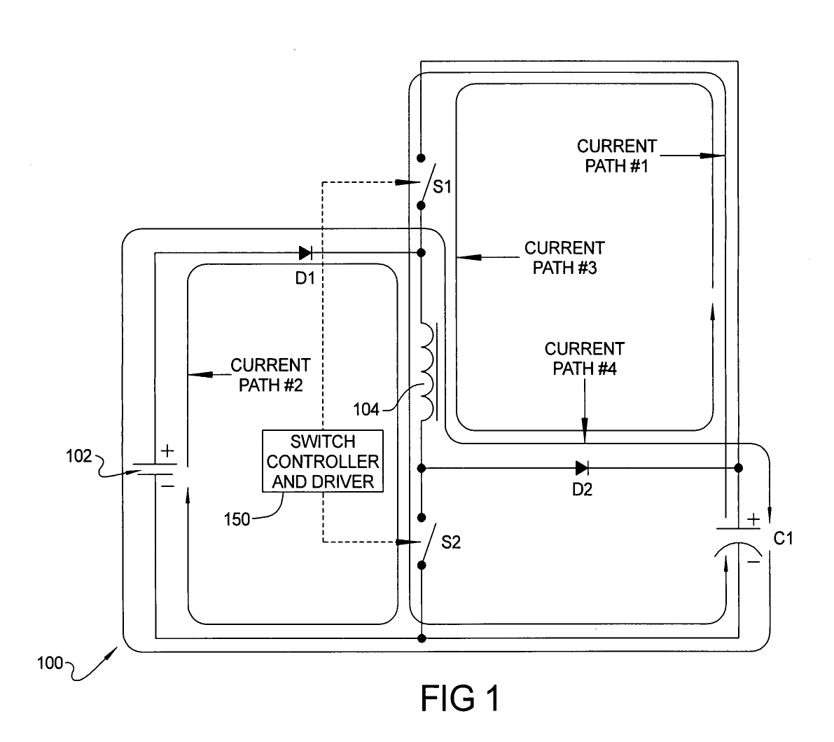

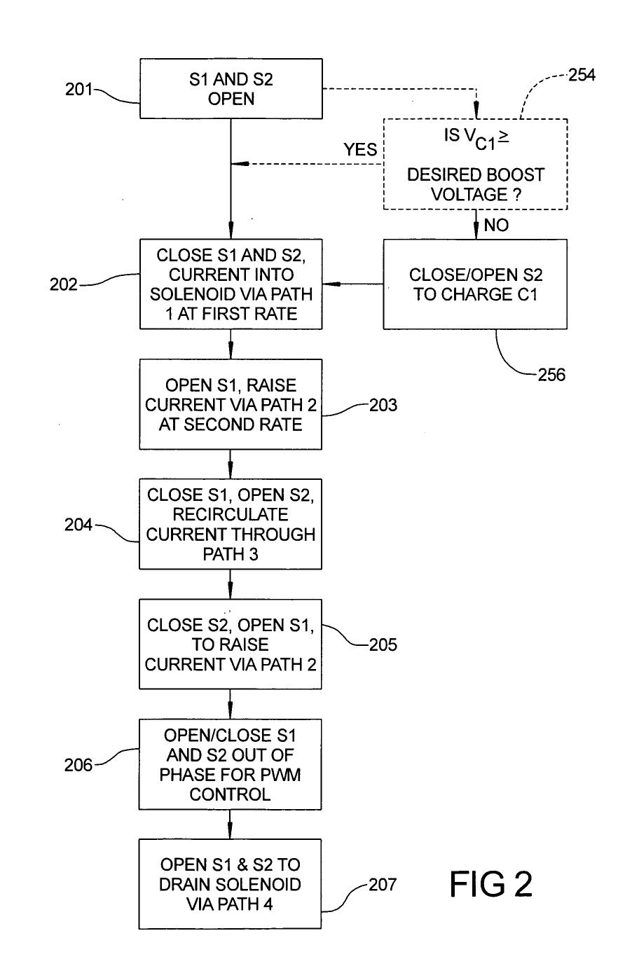

FIG. 1 is a simplified schematic diagram of a circuit 100 according to one embodiment of the invention. FIG. 2 illustrates a process of controlling solenoid current using various embodiments of the circuits described herein.

Referring to FIG. 1, the circuit 100 includes a power source 102, such as a battery or power supply, that provides energy to drive a solenoid coil 104. The circuit 100 also includes a boost energy storage device C1, such as a boost capacitor or other device, two switches S1, S2, and two diodes D1, D2 that direct current through the circuit 100. The switches S1, S2 may be of any type, such as a semiconductor switch, such as a metal-oxide field effect transistor (MOSFET), a field effect transistor (FET), a bipolar junction transistor (BJT), a silicon controlled rectifier (SCR), or an insulated gate bipolar transistor (IGBT). The switches S1, S2 are controlled by control logic in a switch controller 150, which may be an analog circuit or a controller that controls the various operating modes in the circuit 100 via hysteresis switching or any other appropriate control strategy.

In this embodiment, the cathode of one of the diodes D1 is connected between the first switch S1 and the solenoid 104 and the anode of the diode D1 is connected is connected to the positive terminal of the power source 102. This configuration therefore allows partial discharge of the solenoid 104 to provide rapid actuation. FIG. 1 also shows current paths at various stages of circuit operation, which will be explained in greater detail below.

Referring to FIGS. 1 and 2, both of the switches S1, S2 are in an open state during an initial operating state (block 201). It is assumed that energy is stored in the boost capacitor C1 at this state. When the switches S1, S2 are closed, current flows from the boost capacitor C1 through both of the switches S1, S2 and the solenoid 104, as indicated in FIG. 1 as current path 1 (block 202). As current flows, the boost capacitor C1 discharges at a rate that is determined by the size of the boost capacitor C1 and the size of the solenoid 104 until the boost capacitor C1 voltage reaches the battery voltage. The size of the capacitor C1 is selected based on the value of L/R and the desired circuit response speed, and varying the capacitor C1 size changes the circuit 100 operation.

For example, if the capacitor C1 and the solenoid 104 are both small, the capacitor C1 will fully discharge when it reaches the battery voltage. Because the capacitor voltage and the battery voltage are at similar levels, the changes in the current level will be slower as it approaches the target current.

If the capacitor C1 is large and the solenoid is small 104, however, the capacitor C1 will only partially discharge and remain above the battery voltage. A larger capacitor C1 enables faster response times in the circuit 100 by maintaining the capacitor voltage at a higher level. As a result, the circuit 100 will reach the target current at a faster rate.

At this point, the controller 150 instructs the first switch S1 to open, causing the first diode D1 to start conducting current (block 203). The current through the solenoid 104 rises and travels through current path 2 at a slower rate. Note that this stage is optional; if a faster current rise time is desired, the boost capacitor C1 may be charged to a higher level so that the capacitor voltage is kept high and reaches the battery voltage before it is completely discharged, allowing the target current level to be reached at a faster rate.

When the current in the solenoid 104 has reached a final desired level, the second, lower switch S2 opens and the first switch S1 is closed (block 204). The magnetic field in the solenoid 104 inductance “collapses,” “causing the inductor current to recirculate through the solenoid 104 to maintain the magnetic field of the solenoid 104. This in turn forces the current to flow through the second diode D2, which acts as a steering diode, according to current path 3. At this point, the current level gradually drops at a slower rate due to resistive losses in the circuit 100. When the current has decreased to a desired second, lower level, the controller S2 closes the second switch S2 and opens the first switch S1, causing the first diode D1 to conduct supply current from the battery 102 and direct current according to current path 2 again to increase the solenoid current level (block 205). The level at which this occurs can be selected and controlled by the controller 150 based on, for example, the system's tolerance to current ripple, switching losses, noise generation, etc.

Thus, the current in the solenoid 104 can be controlled to conduct PWM operation. In one embodiment, the controller 150 obtains the PWM action at the slower rate by alternately opening and closing the switches S1, S2 out of phase with each other, causing the solenoid current to toggle between current path 2 (charging the solenoid 104 from the battery 102) and current path 3 (recirculating the current from the solenoid to the capacitor C1) (block 206).

To improve operating efficiency, the inventive circuit 100 may recover and re-use magnetic energy stored in the inductance of the solenoid 104 after the solenoid 104 has been actuated. The energy is captured in the boost capacitor C1 and re-used during the next solenoid actuation. This energy capture can be conducted when the solenoid current is dropped rapidly to zero. More particularly, it is desirable to have the current level respond according to the first, faster time constant t₁. To do this, the controller 150 opens both of the switches S1, S2 to drain current from the solenoid 104 into the boost capacitor C1 through current path 4 and both of the diodes D1, D2 (block 207). The boost capacitor C1 will charge to a voltage level higher than the battery 102 voltage; the exact level is controlled by the inductance of the solenoid 104, the amount of current flowing through the solenoid 104 during discharge, and the capacitance.

Note that the battery 102 also helps recharge the boost capacitor C1 because it is placed in the solenoid discharge path in the circuit 100. As a result, the inventive circuit 100 conducts current rise and decay at a first fast rate and at a second slow rate, depending on the specific circuit configuration. This improves the response time and control over solenoid operation. Moreover, the circuit configuration also improves efficiency by using energy captured during discharge of the solenoid.

As noted above, the operation of the circuit 100 in FIG. 1 can be varied by changing the storage capacity of the energy storage device C1. If a larger capacitor C1 is used in the circuit 100 of FIG. 1, it is possible to achieve even faster actuation times due to the increased capacitor storage capacity. The capacitor C1 in this cases reaches a voltage that is higher than the battery 102 voltage and acts as a boost voltage source for the solenoid 104. This increased storage capacity allows the capacitor C1 to discharge only partially rather than completely, supplying current to the solenoid 104 at a near constant voltage and at a faster rate than the circuit of FIG. 1 until the solenoid current reaches a desired level.

Using a larger capacitor C1 also allows recapture of discharged energy from the solenoid 104 into the boost capacitor C1. In this case, however, opening both of the switches S1, S2 to rapidly reduce the solenoid current to zero forces the solenoid voltage to increase to V_{solenoid}=V_{capacitor}+I×R−V_{battery}. This increase causes the solenoid 104 to transfer its magnetic energy to the boost capacitor C1 at a faster rate than the circuit in FIG. 1 because the initial voltage of the capacitor C1 is higher than the battery voltage due to the partial discharge of the capacitor C1.

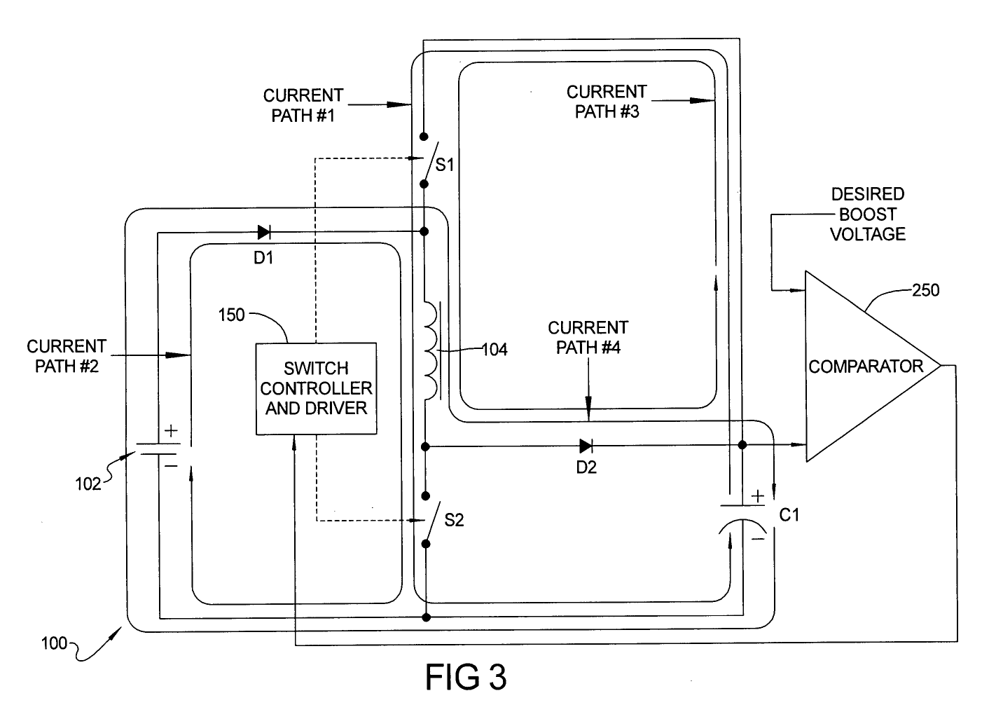

FIG. 3 shows another possible embodiment of the inventive circuit 100. As described above, the inventive circuit 100 may use magnetic energy recovered from solenoid discharge to increase the actuation speed of the solenoid 104 during a later operation cycle. In practice, however, the energy that can be retrieved from the solenoid 104 and stored in the boost capacitor C1 is often less than the energy actually required for operation due to resistive losses, eddy current losses, and core losses. As a result, additional energy needs to be supplied to the boost capacitor C1 after each solenoid actuation to maintain a high actuation speed.

To achieve this, the circuit 100 in FIG. 3 includes a comparator 250 that is coupled to the switch controller 150. The general operation of the circuit 100 is the same as described above with respect to FIG. 2 with additional steps marked in FIG. 2 in dotted lines. In this embodiment, before the solenoid 104 is actuated, the comparator 250 first checks whether the voltage across the boost capacitor C1 is less than the desired boost voltage (block 254). If so, it indicates that the energy discharged from the previous solenoid actuation is not enough to increase the solenoid actuation speed sufficiently for the current operation.

To increase the energy stored in the boost capacitor C1, the switch controller 150 opens and closes the second switch S2. Closing the second switch S2 causes more current to flow from the battery 102 to the solenoid 104 via current path 2, while opening the second switch S2 causes the current created from the collapsing magnetic field in the solenoid 104 to flow into the boost capacitor C1 for storage via current path 4. The controller 150 continues to open and close the second switch S2 to charge the boost capacitor C1 until the comparator 250 indicates to the controller 150 that the capacitor voltage has reached the desired boost voltage value (block 256). At this point, the controller 150 opens the second switch S2, and the process in FIG. 2 continues as described above. As a result, this embodiment allows the solenoid 104 to act as an effective voltage boost source for the capacitor C1.

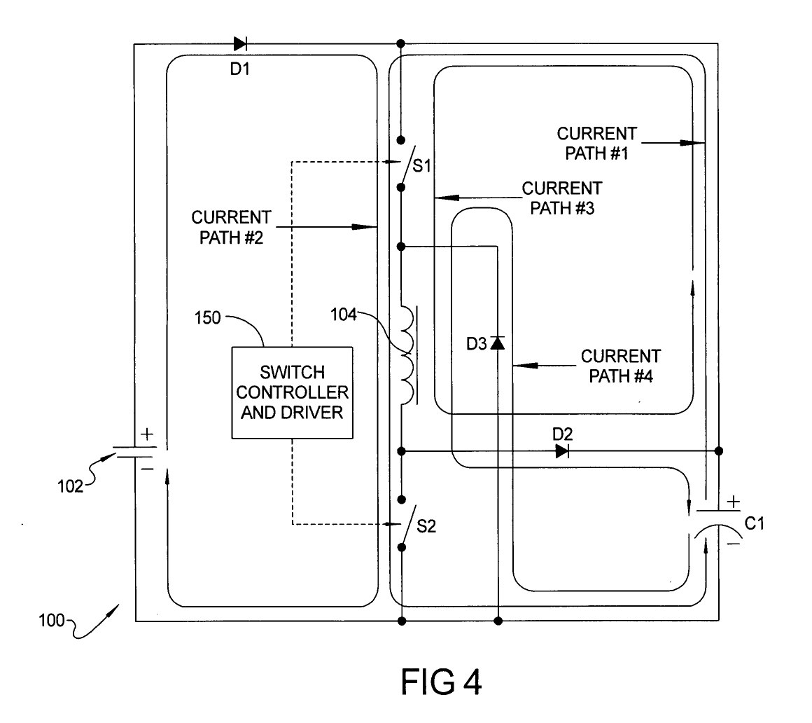

FIG. 4 shows a circuit 100 according to yet another embodiment of the invention. This circuit 100 is designed so that the capacitor completely discharges when it supplies current to the solenoid 104. Like the embodiments described above, the inventive circuit 100 has a time constant that is determined by the time needed for the boost capacitor C1 to discharge energy to or absorb energy from the solenoid 104 rather than strictly according to the L/R time constant. This embodiment differs from the embodiment shown in FIG. 1 by placing an additional diode D3 in current path 3, which directs current when the magnetic field in the solenoid 104 collapses, and moving the location of diode D1 to a location above the switch S1. This circuit isolates the capacitor C1 across the solenoid 104 rather than placing it in series with the battery 102 as in FIG. 1. This results in a circuit 100 that has a faster response during coil turn-off.

The circuit 100 in FIG. 4 operates in the manner described above in FIG. 2. In this embodiment, the boost capacitor C1 charges to a voltage level based on the energy stored in the solenoid 104, less the voltage drop across diodes D2 and D3. Note that in this embodiment, the voltage level that the boost capacitor C1 can reach is lower than the voltage that the boost capacitor C1 can reach in FIG. 1 because the new position of the diode D1 prevents the solenoid 104 from being repetitively charged and discharged to increase the capacitor C1 voltage in this circuit 100.

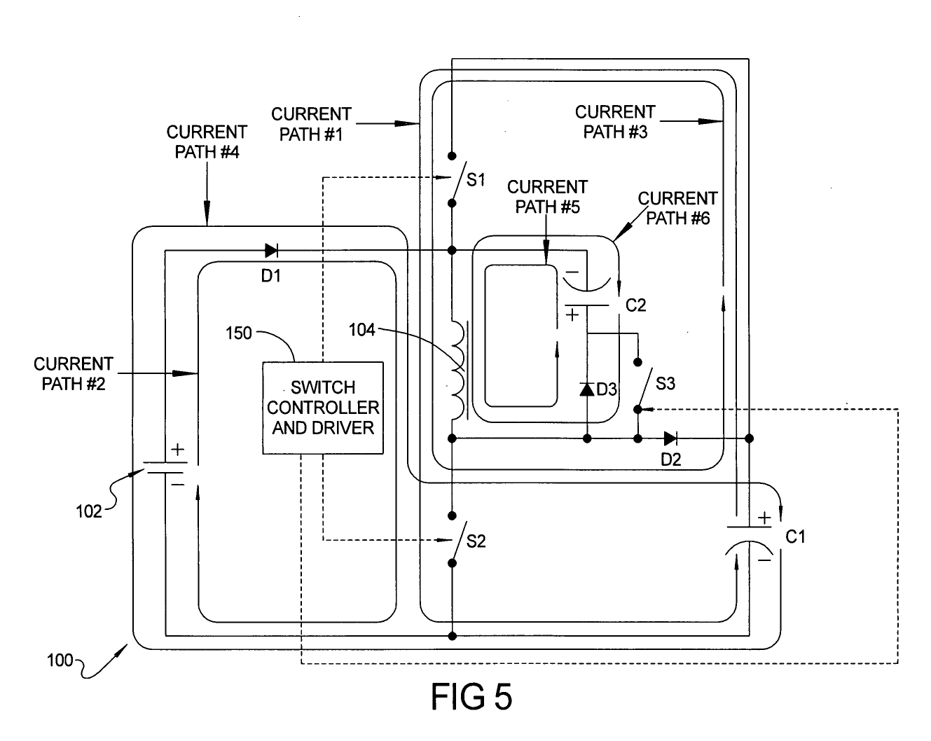

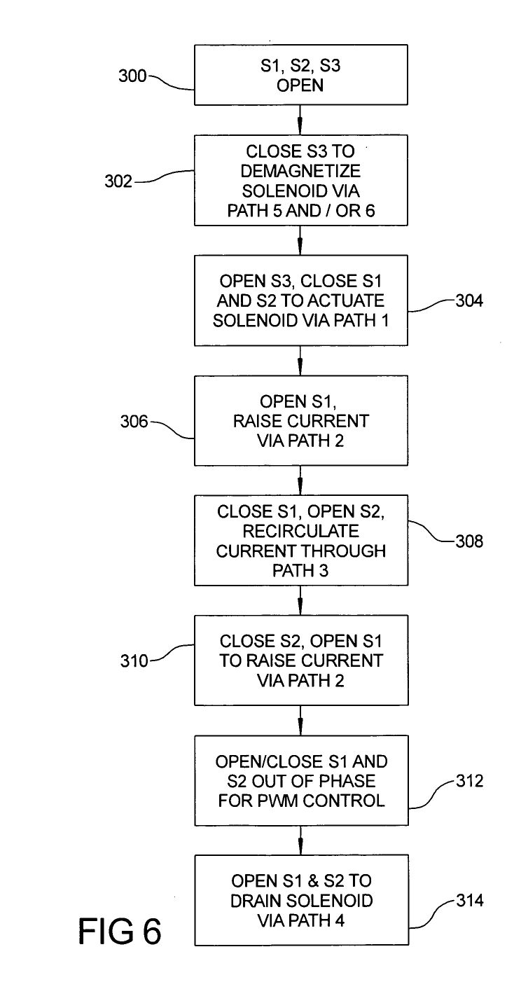

FIG. 5 illustrates yet another embodiment of the inventive circuit 100. This embodiment is similar to the embodiment shown in FIG. 4 except that it includes an additional switch S3 disposed in parallel with the additional diode D3 and a demagnetization storage device C2, such as another capacitor, disposed in series with the additional diode D3. This creates two additional circuit paths, which will be described in greater detail below. FIG. 6 is a flow diagram illustrating the operation of the circuit in FIG. 5. Note that the diode D3 and the switch S3 may be combined into one device, such as a MOSFET.

Referring to FIGS. 5 and 6, the circuit 100 has all three switches S1, S2, and S3 open at the start of its operational cycle (block 300). It is assumed that both the energy boost capacitor C1 and the demagnetization capacitor C2 are both charged to nominal operational values at this stage.

The third switch S3 is then closed just before the solenoid 104 is to be actuated, causing current to flow from the demagnetization capacitor C2 through the solenoid 104 via current path 6 (block 302). In one embodiment, this step demagnetizes the solenoid 104. The demagnetization can be conducted by, for example, applying current through the solenoid that is either a pulse or a decaying sinusoid, depending on the size of the demagnetization capacitor C2. If the demagnetization capacitor C2 is large (e.g., greater than 10% of the boost capacitor C1 value), then the third switch S3 will close for a short time (e.g., tens of microseconds) to conduct pulse demagnetization. If the demagnetization capacitor C2 is small (e.g., on the order of 1% to 10% of the boost capacitor C1 value), then the switch S3 will close for a longer time period (e.g., several milliseconds) to conduct decaying sinusoid demagnetization. Note that during sinusoid demagnetization, the demagnetization capacitor C2 will completely charge and discharge with an alternating polarity and decreasing amplitude through current paths 5 and 6 at this step (block 302).

After the solenoid 104 has been demagnetized, the third switch S3 opens and switches S1 and S2 close to start solenoid actuation (block 304), causing current to flow from the boost capacitor C1 through the two closed switches S1, S2 and the solenoid 104 via current path 1. Like several of the embodiments described above, the boost capacitor C1 in this embodiment has a voltage much higher than the battery 102 voltage and sufficient capacity to discharge only slightly while supplying current to the solenoid 104 at a near-constant voltage until the solenoid current reaches a desired level. Once this occurs, the first switch S1 is opened, conducting current through diode D1 via current path 2 at a slower rate as described above in the previous embodiments (block 306).

The remaining steps 308, 310, 312 and 314 in the process of FIG. 7 are the same as blocks 204, 205, 206 and 207 of FIG. 2. Note that when the first and second switches S1 and S2 are opened at the end of the process to rapidly reduce the solenoid current to zero, the solenoid voltage increases to (V_{boost capacitor}+V_{demagnetization capacitor)})+(I×R)−Vbattery (block 314). This causes the inductor to transfer its magnetic energy to both the demagnetization capacitor C2 and the boost capacitor C1. The demagnetization capacitor C2 changes to a voltage that is approximately equal to V_{boost capacitor}−V_{battery}. The battery 102 can also help charge the two capacitors C1, C2 because it is in the discharge path.

The circuits above can be used in any application using solenoid valves. For example, the driver circuit may be used to enhance controllability of a spool valve by demagnetizing the spool and an end cap so that the spool can move to another position. Those of ordinary skill in the art will recognize that the inventive circuit can be used in other applications without departing from the scope of the invention.

By incorporating inductor-capacitor energy transfer principles in the drive circuit, the invention increases the actuation speed of a solenoid driven by the circuit and provides selectable time constants to improve PWM capability. Moreover, capturing and re-using stored energy in the inventive circuit improves the energy efficiency of the circuit. A spool valve operating according to the inventive principles experiences a decreased actuation time and enhanced controllability. Those of ordinary skill in the art will understand that the switching time in the inventive circuit can be controlled or modified based on the response of the solenoid or the response of other portions of the system, (e.g., spool response, pressure rate rise, system downstream behavior, etc.).

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A drive circuit, comprising:
a solenoid;
a boost device that stores energy; and
at least one switch that controls current flow through the solenoid and the boost device by directing energy from the boost device to the solenoid in a first state and directing energy from the solenoid to the boost device for storage in a second state,
wherein at least one of a current rise rate and a current fall rate in the solenoid is controlled by the solenoid and the boost device.

2. The drive circuit of claim 1, wherein the boost device is a capacitor.

3. The drive circuit of claim 1, wherein the boost device has a storage size less than or equal to an energy storage requirement for complete charging of the solenoid to allow complete discharge of the boost device.

4. The drive circuit of claim 1, wherein the boost device has a storage size greater than an energy storage requirement for complete charging of the solenoid to allow partial discharge of the boost device.

5. The drive circuit of claim 1, wherein said at least one switch is a semiconductor switch.

6. The drive circuit of claim 1, further comprising:
a comparator that compares a desired boost voltage with a voltage across the boost device; and
a switch controller that controls said at least one switch to discharge the solenoid into the boost device if the comparator indicates that the voltage across the boost device is lower than the desired boost voltage.

7. The drive circuit of claim 1, further comprising a demagnetization device for demagnetizing the solenoid.

8. The drive circuit of claim 7, wherein the demagnetization device is a capacitor having a value that provides pulse demagnetization.

9. The drive circuit of claim 7, wherein the demagnetization device is a capacitor having a value that provides decaying sinusoidal demagnetization.

10. A drive circuit, comprising:
a solenoid;
a power source;
a boost device that stores energy;
a first switch and a second switch that control current flow through the solenoid and the boost device by discharging energy from the boost device to the solenoid in a first state and directing energy from the solenoid to the boost device for storage in a second state,
a switch controller that controls operation of the first switch and the second switch;
a first current steering device and a second current steering device that selectively direct current through the solenoid, the power source, and the boost devices based on the states of the first switch and the second switch;
wherein at least one of a current rise rate and a current fall rate in the solenoid is controlled by the solenoid and the boost device at a first rate and a second rate slower than the first rate.

11. The drive circuit of claim 10, wherein
the first and second switches are disposed in series with the solenoid,
the second switch and the solenoid are disposed in parallel with the power source, and
the second switch is disposed in parallel with the boost device.

12. The drive circuit of claim 10, wherein the first current steering device is disposed in series with the power source and the second current steering device is disposed in series between the second switch and the boost device.

13. The drive circuit of claim 10, further comprising:
a comparator that compares a desired boost voltage with a voltage across the boost device; and
a switch controller that controls at least one of the first and second switches to charge the boost device if the voltage across the boost device is lower than the desired boost voltage.

14. The drive circuit of claim 10, further comprising a third current steering device disposed in parallel with the solenoid and the second switch.

15. The drive circuit of claim 10, further comprising:
a third current steering device disposed in parallel with the solenoid;
a demagnetization device coupled to the third current steering device; and
a third switch disposed in parallel with the third current steering device.

16. A method for operating a drive circuit having a solenoid, a power source, a boost device that stores energy and at least one switch that controls current flow through the solenoid, the method comprising:
charging the solenoid by discharging current from the boost device to the solenoid at a first rate, and
charging the solenoid from the power supply at a second rate slower than the first rate;
discharging the solenoid; and
charging the boost device during the discharging step by capturing energy from the solenoid during the discharging step in the boost device.

17. The method of claim 16, further comprising repeating the steps of charging the solenoid and discharging the solenoid before the reducing step.

18. The method of claim 16, further comprising:
comparing a voltage across the boost device with a desired boost voltage; and
charging the boost device with the power supply if the voltage across the boost device is lower than the desired boost voltage.

19. The method of claim 16, wherein the circuit further comprises a demagnetization device, and wherein the method further comprises discharging current from the demagnetization device into the solenoid before the step of charging the solenoid.

20. The method of claim 19, wherein the step of discharging current from the demagnetization device conducts pulse demagnetization.

21. The method of claim 19, wherein the step of discharging current from the demagnetization device conducts decaying sinusoidal demagnetization.

22. A drive circuit, comprising:
a solenoid;
a boost device that stores energy, wherein at least one of a current rise rate and a current fall rate in the solenoid occurs at a first rate and at a second rate different than the first rate;
a controller that controls current flow through the solenoid and the boost device according to a plurality of operating modes, in which
in a first operating mode, current flows from the boost device to the solenoid at the first rate;
in a second operating mode, current alternately flows between the solenoid and the boost device at the second rate.

23. The drive circuit of claim 22, further comprising a plurality of switches, wherein the controller determines at least one switching time for conducting the first and second operating modes.

24. The drive circuit of claim 22, wherein the controller controls current flow according to at least one of a solenoid current, boost device voltage, solenoid response, or an external system response.

25. The drive circuit of claim 22, further comprising a comparator that compares a voltage across the boost device with a desired boost voltage, wherein the controller directs current from the solenoid into the boost device if the voltage across the boost device is lower than the desired boost voltage.

26. The drive circuit of claim 22, further comprising a demagnetization device, wherein the controller directs current from the solenoid to the demagnetization device to transfer magnetic energy from the solenoid to the demagnetization device.
